(19) United States
(12) Patent Application Publication
(10) Pub. No.: US 2007/0040309 A1
(43) Pub. Date: Feb. 22, 2007

(54) Light weight spring for vehicle suspension and method of manufacture

(76) Inventor: Nirmal M. Tolani, Fort Wayne, IN (US)

Correspondence Address: INTERNATIONAL TRUCK INTELLECTUAL PROPERTY COMPANY,, 4201 WINFIELD ROAD, P.O. BOX 1488, WARRENVILLE, IL, 60555, US

(21) Appl. No.: 11/207,639

(22) Filed: Aug. 19, 2005

(51) Int. Cl. B60G 11/02

(52) U.S. Cl. 267/36.1

(57) ABSTRACT

A light weight leaf spring is provided by hydroforming the spring to provide a spring with a hollow cross section.

### BACKGROUND OF THE INVENTION

1. Technical Field

The invention relates to spring of reduced weight and material cost for motor vehicle suspensions.

2. Description of the Problem

Truck suspension systems provide isolation of passengers and cargo from road shock while keeping the vehicle stable and preserving operator control. These objectives are met using combinations of springs, motion damping devices and auxiliary axle positioning elements. Achieving acceptable levels of performance, while supporting the vehicle's weight over a wide range of vehicle load conditions, is preferably achieved with a mechanically simple, compact and light weight suspension system.

The central element of any suspension system is the spring, and the four most popular, basic types of suspension systems used on trucks are categorized by the spring used, e.g.: flat spring systems; equalizing beam systems; torsion bar systems; and, air spring systems. Hybrid combinations of these are also used. Flat spring systems come in various configurations including leaf springs, half leaves, hockey sticks, and the like.

Flat spring systems have remained popular on heavy duty vehicles based on cost and simplicity of design. They augment or substitute for auxiliary stabilization components to maintain the proper location and attitude of the axle with respect to the vehicle and to prevent excessive vehicle roll and thus are readily used with air springs to form a hybrid system. However, some configuration of flat springs, such as multi-leaf designs and solid flat springs exact weight and material cost penalties as the price of their advantage in simplicity of application.

Very light springs have been proposed fabricated as a curved, hollow tube. Such tubes have been flattened at opposite ends, and have cross sections which vary progressively from the center part of the tube toward the opposite ends. The thickness of the spring may vary as a flattened parabolic.

Hydroforming uses internal fluid pressure to maintain the integral construction of a tube form while shaping the tube to a desired external configuration in a die. The process of hydroforming begins with a tubular blank of predetermined length and wall thickness. The tubular blank may be pre-bent mechanically. An end of the tubular blank is sealed and the tube is internally pressurized by injection of liquid from the other end. Eventually fluid pressure is then raised to support internally the walls of the tubular blank but not high enough to form outward bulges in the wall. With the walls internally supported by the pressurized liquid, the tube may be shaped to the desired final section and configuration.

Once the tube has been bent, the tubular blank may be positioned in a die which conforms its shape and which includes cavities conforming to features to be imposed on the tubular blank. The shapes imposed on the external surface of the tube may be relatively complex. Internal liquid pressure is now increased until the tube walls began to bulge into the secondary cavities. While this is occurring the ends of the tube may be subjected to longitudinal compression to maintain nominal wall thickness.

### SUMMARY OF THE INVENTION

According to the invention there is provided a leaf spring comprising, at least a first tubular leaf having an inner cavity and opposite ends which are constricted in cross section. The cross section of leaf varies smoothly from end to end. The tubular leaf is fabricated from an unjointed single element, shaped by hydroforming. A viscoelastic material may be used to fill the inner cavity of the spring to provide sound and vibration damping.

Additional effects, features and advantages will be apparent in the written description that follows.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a perspective view of a vehicle rear suspension system incorporating the improved spring of the present invention.

FIGS. 2A and B are a top plan and a side elevation, respectively, of a hockey stick shaped spring in accordance with the teachings of the present invention.

FIG. 3 is a side elevation view of a “Z” shaped spring.

FIGS. 4A-C are cross sectional views of the flattened parabolic spring of FIG. 3.

FIG. 5 is a side elevation of another embodiment of a flattened parabolic spring.

FIG. 6 is a side elevation of a flattened parabolic spring of an alternative configuration.

FIG. 7 is a cross sectional view for either of the parabolic springs of FIG. 5 or 6.

### DETAILED DESCRIPTION OF THE INVENTION

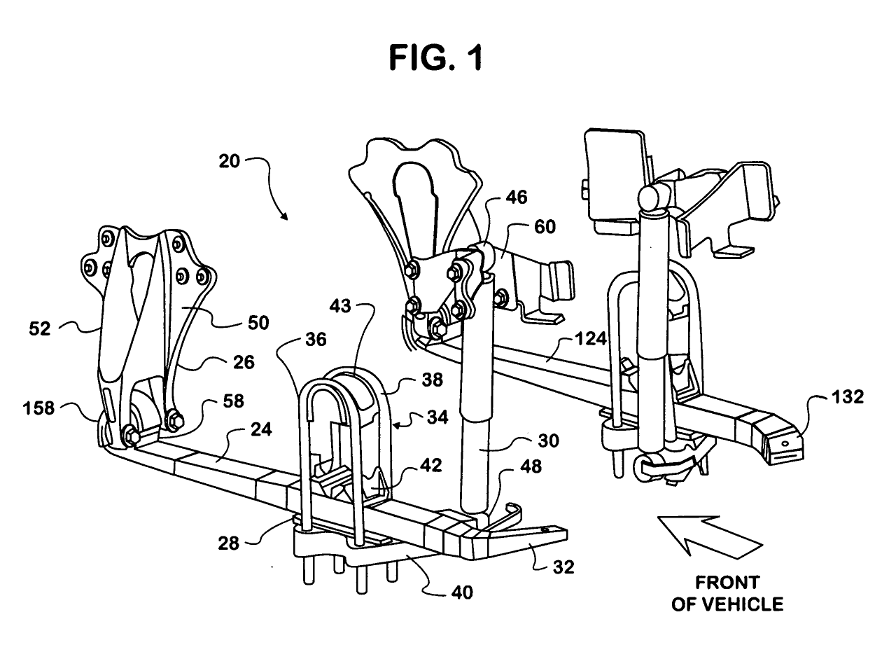

Referring now to the figures and in particular to FIG. 1, a suspension system 20 for a motor vehicle is illustrated comprising left and right side subassemblies. Suspension system 20 may include air springs (not shown) which are supported upon trailing left and right side, single, hockey stick members 24, 124. Hockey stick members 24, 124 are hollow section, hydroformed elements which advantageously provide high strength at reduced weight compared with conventional solid members. Hockey stick members 24, 124 include turned in sections 32, 132 giving the springs a characteristic hockey stick shape. By the term “turned in” it is meant that sections 32 and 132 point inwardly toward the longitudinal center line of the vehicle from the side on which they are located relative to the main bodies of the members 24, 124, which parallel the long sides of the vehicle (not shown) and the center line. Turned in sections 32, 132 provide an installation point for an air spring bladder, if desired. Mounting support detailing may also be formed in the surface of the members 24, 124 for the purposes of supporting such an installation.

The two sides of suspension system 20 being the same, only the left side partial assembly is discussed here. Hockey stick member 24 pivotally depends from a hanger 26, which in turn depends from a vehicle chassis frame rail (not shown). Hanger 26 comprises two sections 50, 52 and a pin and bushing hinge joint 58, set between the section from which hockey stick member 24 depends by an end loop/eye 158. Hockey stick member 24 is secured to an axle (not shown) by a coupling 34 located substantially centrally lengthwise along the member. Coupling 34 is conventional, including a base plate 40 disposed under the member 24 and a shim 28 positioned between the base plate and the bottom surface of the member. Base plate 40 provides points of mounting for first and second U-bolts 36,38 and a shock absorber 30. Forms 42, 43 are shaped to fit around the top and bottom of an axle (not shown). Shock absorber 30 is attached to base plate 40 and frame rail 60, bottom and top, by pivot joints 48, 46, respectively. The details of connection of member 24 to hanger bracket 50 and to an axle are not significant other than in regard that some mechanism for connection is provided.

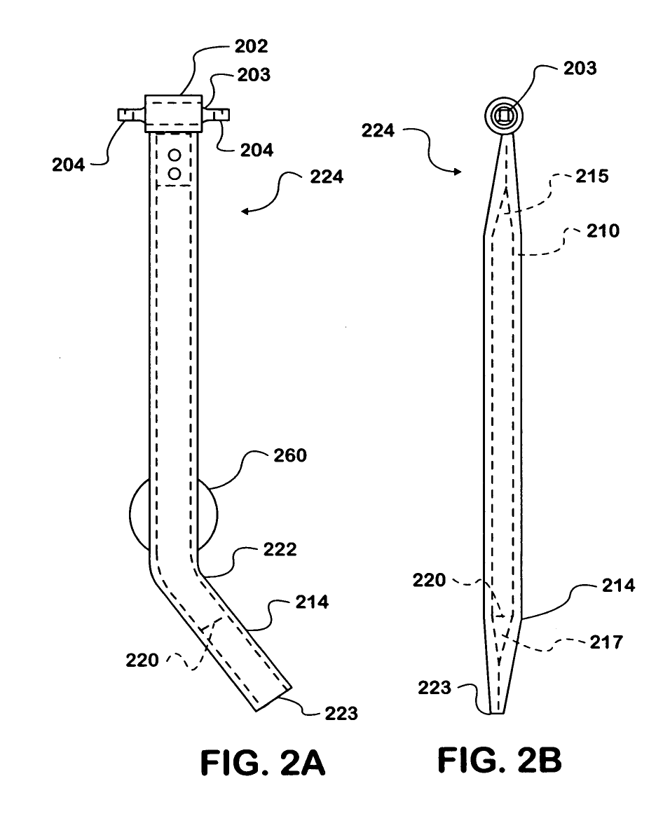

FIGS. 2A-B are illustrative of a possible configuration of a trailing hockey stick member 224. Hockey stick member 224 is hollow with a central passage 210 and progressively constricted end sections 215 and 217. Spring 224 has a rectangular cross sectional shape the dimensions of which vary from assembly 202 to end 223. This is achieved by hydroforming as described below. End assembly 202 is used to provide a connecting link to a hanger bracket. End assembly 202 fits a conventional suspension hanger, being mounted therein at the ends of shaft 204. Central passage 210 may be filled with a viscoelastic core 220, such as rubber, to provide damping.

The hydroforming of spring 224 is conventional in using internal fluid pressure to maintain the integral construction of a tube form while shaping the tube to a desired external configuration in a die. Hydroforming produces a hollow spring of substantially reduced material thickness improving heat treatability. With the walls internally supported by the pressurized liquid, the tube may be shaped to the desired configuration to produce the hockey stick form, or the Z-shape form described below. Secondary features on the exterior surface such as a platform 260 for positioning an air spring might be added. The resulting springs have a hollow cross section, but no joint where sections of the member were applied to one another. The tube material may be obtained in much better surface quality than the hot rolled solid bars used in the past. This promises an improvement in fatigue performance.

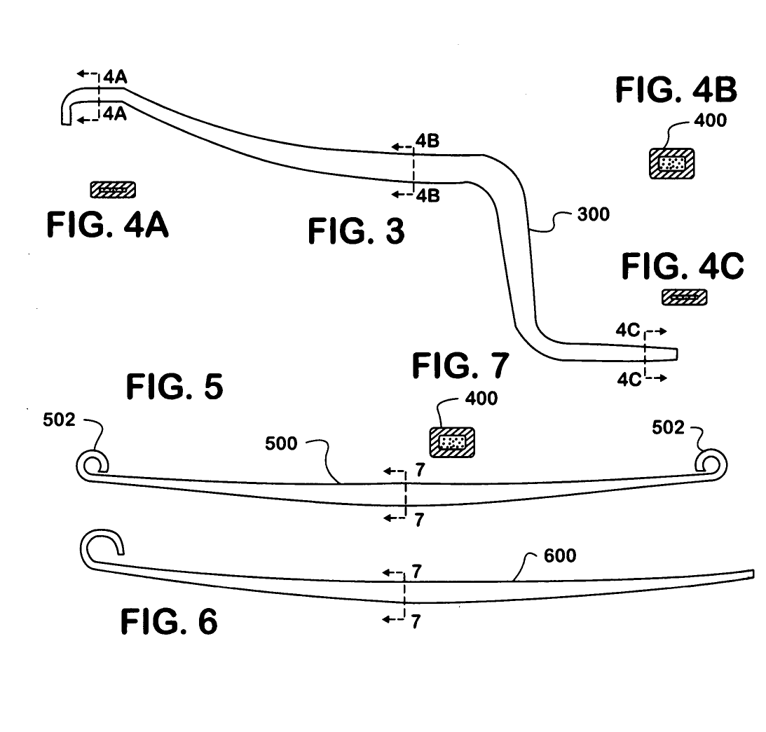

FIGS. 3, 5 and 6 present alternative configurations for springs, all of which may be advantageously formed using hydroforming to produce hollow cross sectional elements in a flattened parabolic form. Spring 300 conforms to what is termed a Z-shape. Cross sectionally spring 300 is open toward the center (as shown in FIG. 4B), allowing the center to be filled with a rubber, visco-elastic material 400. The ends (shown in FIGS. 4A and C) are constricted, holding the position of the visco-elastic material. Springs 500 and 600 are similarly configured, although shaped more conventionally. Spring 500 includes end loops or eyes 502.

The present invention provides a light weight, high strength spring which requires less material to fabricate. The invention allows the use of alternate, lower cost, low alloy steels and the possibility of the use of steels with better surface qualities.

While the invention is shown in only a few of its forms, it is not thus limited but is susceptible to various changes and modifications without departing from the spirit and scope of the invention.

What is claimed is:

1. A spring comprising:
at least a first tubular section having an inner cavity and an end which is constricted in cross section which varies smoothly from end to end;
said at least first tubular leaf being an unjointed single element, shaped by hydroforming.

2. A spring according to claim 1, further comprising:
a viscoelastic material substantially filling the inner cavity.

3. A spring according to claim 1, further comprising:
external shaping to an exterior surface to provide a platform for a supplementary suspension element.

4. A method of forming a flattened parabolic spring, comprising the steps of:
providing a hollow tube form;
filling the hollow tube form with a liquid; and
placing the hollow tube form in a die for a spring and increasing liquid pressure to force the hollow tube form to conform to the die and assume the shape of a flattened parabolic spring.

5. A method of forming a spring according to claim 4, comprising the further steps of:
filling the conformed hollow tube form with a viscoelastic material.
